(19) United States
(12) Patent Application Publication
(10) Pub. No.: US 2008/0210501 A1
(43) Pub. Date: Sep. 4, 2008

(54) Assistive Front Electric Brakes For Gas Or Electric Vehicles

(75) Inventor: Warren Clark, Evans, GA (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/681,220

(22) Filed: Mar. 2, 2007

(51) Int. Cl. B60L 7/00

(52) U.S. Cl. 188/161; 188/158

(57) ABSTRACT

A front electric brake assembly for assisting vehicle braking is provided. The front electric brake assembly includes a spindle that includes at least one mounting flange. A shaft extends substantially perpendicular from the spindle. An electric brake mounts to the at least one mounting flange of the spindle. A hub assembly rotates about the shaft and interconnects with the electric brake.

### FIELD

The present disclosure relates to electric brake systems and to front electric brake systems for assisting vehicle braking.

### BACKGROUND

The statements in this section merely provide background information related to the present disclosure and may not constitute prior art.

Electric brakes are equipment drive assemblies that use electrically actuated components to slow or stop shafts. Various electric brakes are electrically actuated but rely on mechanical friction to provide braking torque. Various other electric brakes rely on the creation of an electrical force to provide the braking torque. While still other electric brakes combine the electrical force with mechanical friction to provide braking torque.

Electric brakes that rely on mechanical friction are typically used in applications that require fast response times and precise application of a braking force control. This type of electric brake is commonly used on rear wheels of vehicles. Such brakes are frequently the preferred electric brakes when the load must be brought to a full stop. These brakes are generally referred to as friction brakes as they generate friction between contact surfaces. A consequence of the conventional electric braking technique is that the materials that physically rub together eventually wear away and must be occasionally replaced.

Electric brakes that rely on an electrical force are primarily used to provide drag or retarding action where a rapid or precise full stop is not needed. This type of electric brake is commonly used in RV and utility trailers to assist a vehicle in bringing the load to a complete stop. Common examples include magnetic-particle, hysteresis, and eddy-current brakes. Such brakes are considered non-contact brakes, as braking energy is applied to the load without physically touching the load.

Integrating any of these various types of electric brakes into the front wheel suspension systems is desirable to assist with vehicle braking.

### SUMMARY

Accordingly, a front electric brake assembly for assisting vehicle braking is provided. The front electric brake assembly includes a spindle that includes at least one mounting flange. A shaft extends substantially perpendicular from the spindle. An electric brake mounts to the at least one mounting flange of the spindle. A hub assembly rotates about the shaft and interconnects with the electric brake.

In other features, an assistive front electric braking system for vehicles is provided. The system includes a left electric brake splined to a left front hub assembly for assisting vehicle braking. A right electric brake is splined to a right front hub assembly for simultaneously assisting vehicle braking. A brake detection device detects a position of a brake pedal and generates an electrical signal based the position. A switching device responds to the electrical signal and generates a second and a third electrical signal to the left and the right electric brakes respectively.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side perspective view of a light-weight utility vehicle including an assistive front braking system, in accordance with various embodiments.

FIG. 2A is an exploded perspective view of the assistive front electric brake assembly shown in FIG. 1, in accordance with various embodiments.

FIG. 2B is an assembled perspective view of the assistive front electric brake assembly shown in FIG. 1, in accordance with various embodiments.

FIG. 3 is a cross sectional view of an electromagnetic brake of the front assistive brake assembly shown in FIG. 1, in accordance with various embodiments.

FIG. 4 is a block diagram illustrating the assistive front electric brake system shown in FIG. 1, in accordance with various embodiments.

### DETAILED DESCRIPTION

The following description of various embodiments is merely exemplary in nature and is in no way intended to limit the present teachings, application, or uses. For purposes of clarity, like reference numbers will be used in the drawings to identify the like elements.

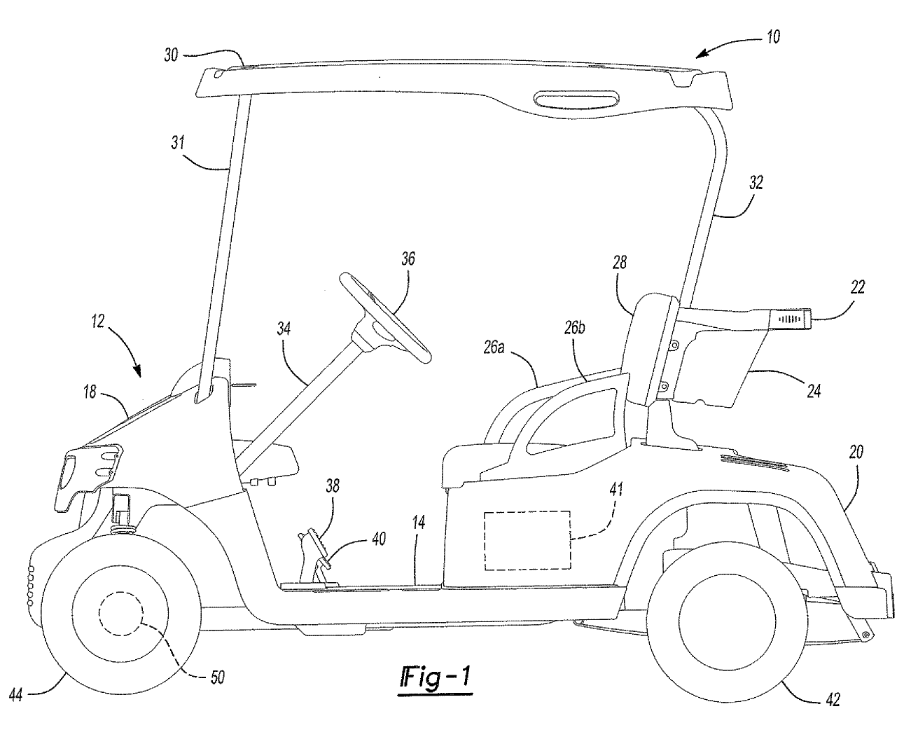

Referring now to FIG. 1, a golf car is shown generally at 10, in accordance with various embodiments. Golf car 10 can include a plurality of conventional components. Such components in their broadest context include a frame, a body, a steering assembly, driver controls, a propulsion system and wheels. Such conventional components are individually configured and cooperate to achieve the desired functional objectives of golf car 10. In various embodiments, the golf car 10 of FIG. 1 includes at least one assistive front electric brake assembly 50, shown generally in phantom. As can be appreciated, golf car 10 or other vehicle types such as light-weight utility vehicles including, but not limited to, maintenance vehicle, cargo vehicles, and shuttle vehicles may include various embodiments of the assistive front electric brake systems according to the present disclosure. For ease of the discussion, the remainder of the disclosure will be discussed in the context of golf car 10.

Golf car 10 includes a frame (not shown) that provides support and structure for golf car 10. A body is mounted to the frame and is shown generally at 12. Body 12 includes a floorboard 14, a bench 16, a front end 18, a rear end 20, a storage unit 22, and a basket 24. Bench 16 is mounted to and located above floorboard 14. Bench 16 has two laterally spaced seats for at least two occupants, a driver and a passenger. Arm-rails 26A and 26B and a seatback 28 mount to and extend above bench 16. Storage unit 22 is located behind bench 16 and can be designed to accommodate at least two golf bags in an upright position. A canopy 30 connects to front struts 31 and back struts 32 extending upwardly from front end 18 and rear end 20 respectively. Basket 24 can connect to back struts 32.

A steering column 34 extends upwardly from floorboard 14 of body 12. Steering column 34 is angled inwardly toward bench 16 adjacent to the driver seat. A steering wheel 36 is provided at the end of steering column 34. Driver controls, including a brake pedal 38 and an accelerator pedal 40, extend outwardly from floorboard 14. Beneath bench 16 of body 12 is a propulsion system 41, shown generally in phantom. The propulsion system 41 typically propels rear wheels 42 of golf car 10 based on input provided from driver controls 38 and 40. The propulsion system 41 may be gas powered or electrically powered. By way of non-limiting example, the various embodiments will be discussed in the context of an electric propulsion system. Typically electric propulsion systems include a motor, a battery pack, and a brake coupled to the motor. Electrical sensors or mechanical actuators control the state of the propulsion system to direct operation of golf car 10.

In various embodiments, golf car 10 includes a left and right assistive front electric brake assemblies 50, shown generally in phantom, that are coupled to left and right front wheels 44, respectively, to provide braking assistance when brake pedal 38 is depressed. The braking assistance can be applied in addition to the braking force provided by the brake of the propulsion system 41 to reduce vehicle speed while attempting to decelerate the vehicle at higher deceleration rates. Such may be the case when golf car 10 is traveling down steep grades, needs to abruptly stop, or is heavily loaded.

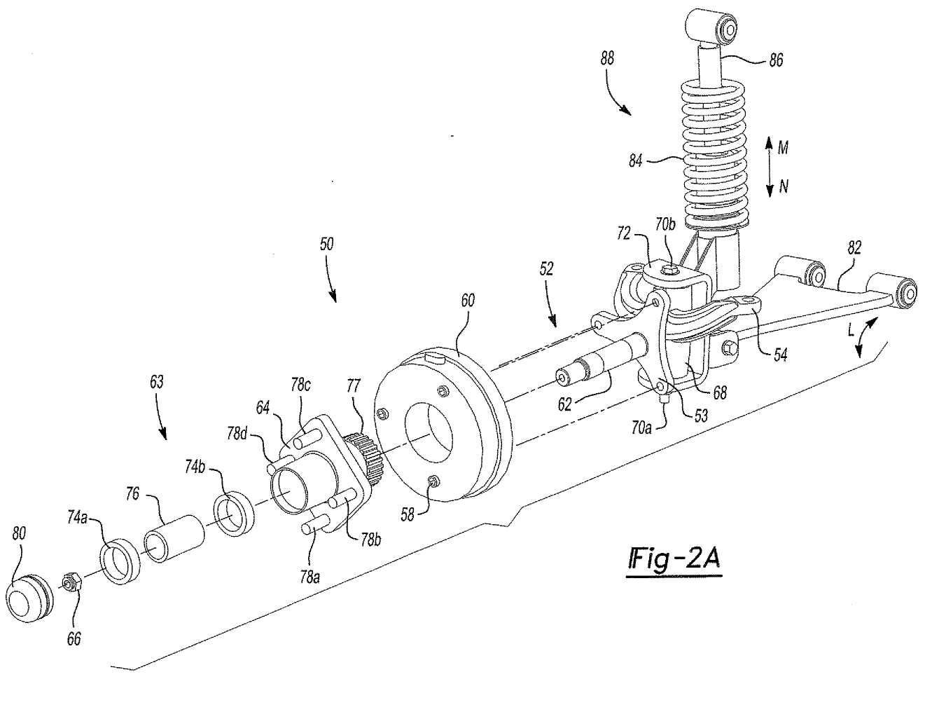

FIGS. 2A and 2B illustrate left front electric brake assembly 50 in accordance with various embodiments. Referring to FIG. 2A, a metallic spindle shown generally at 52 mounts to a steering arm 54. Spindle 52 includes at least one mounting flange 53 for receiving an associated fastener 58 for fastening an electric brake 60 to steering arm 54 via spindle 52. A spindle shaft 62 extends outwardly from spindle 52 for mounting and rotating a hub assembly shown generally at 63. Spindle shaft 62 includes a threaded end portion for receiving a correspondingly threaded nut 66 for retaining the hub assembly 63, including a hub 64, on spindle shaft 62. A generally vertical knuckle 68 having bearings 70A and 70B install to a mounting bracket 72 for the purpose of displacing wheel 44 (FIG. 1) in response to movement of steering wheel 36 (FIG. 1).

Hub assembly 63 interconnects with electric brake 60 and rotates on spindle shaft 62. Hub assembly 63, more specifically includes a bearing set 74A and 74B pressed into metallic hub 64 and retained in metallic hub 64 by a snap ring (not shown). A spacer tube 76 assembles between bearing set 74A and 74B to prevent damage to bearing set 74A and 74B under compressive loading. Studs 78A-D are pressed into corresponding bones in hub 64 in a pattern that matches mounting holes on the rims of a wheel assembly. Nut 66 threads onto spindle shaft 62 to retain hub assembly 63 during operation of golf car 10. Hub 64 includes spline detail 77 that mates internally to friction material in electric brake 60. A dust cap 80 installs to hub 64 over the end of spindle shaft 62 covering nut 66 and hub assembly components.

Assistive front electric brake assembly 50 mounts to a suspension system of golf car 10. Suspension system includes a suspension arm 82 that is pivotally supported by pins to permit knuckle 68, spindle 52, electric brake 60, and hub assembly 63 to pivot about deflection arc ‘L.’ A coil spring 84 and a shock absorber 86 of spring/shock absorber assembly 88 deflect to allow motion of spring/shock absorber assembly 88 in each of a compression direction ‘M’ and an expansion direction ‘N.’ Shock absorber 86 can be fixedly connected via a mounting pin to a support structure such as the frame of golf car 10.

FIG. 2B illustrates an assembled left assistive front electric brake assembly 50, in accordance with various embodiments. Front wheel 44 (FIG. 1) is rotatably mounted on hub 64 along a hub rotation axis 90. Electric brake 60 remains stationary while hub assembly 63 and internal components of electric brake 60 rotate in accordance with the rotation of wheel 44 (FIG. 1). Electrical energy supplied to electric brake 60 via a connector 92 controls a braking torque. As can be appreciated a right assistive front electric brake assembly comprises a mirror image of left front brake assembly 50 and is assembled to the right side of golf car 10.

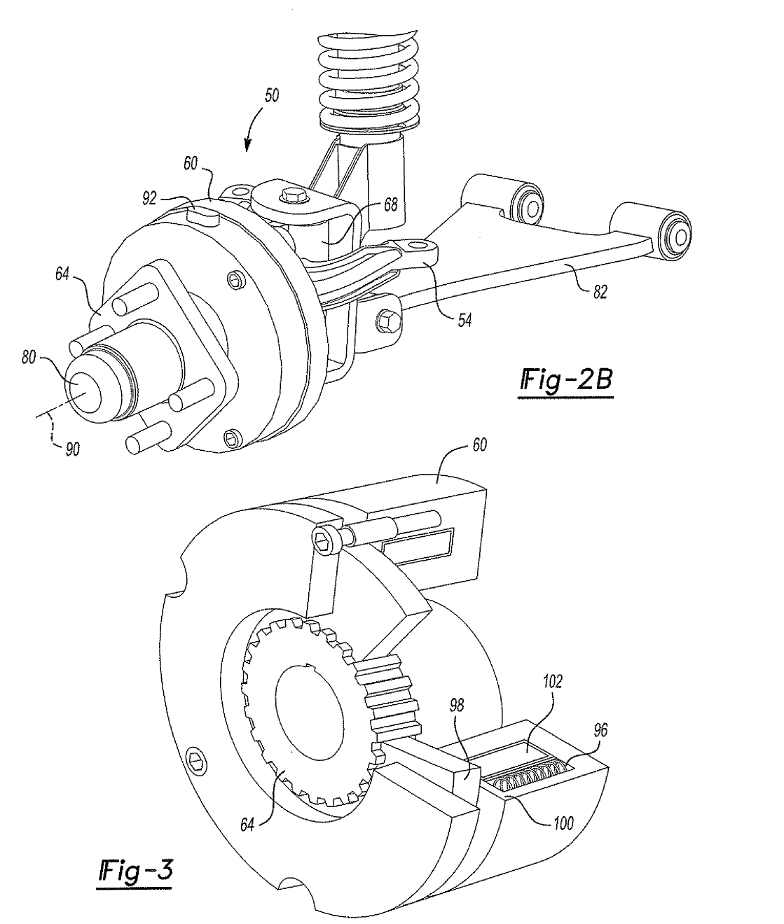

Referring to FIG. 3, a cross-sectional view of electric brake 60 is shown, in accordance with various embodiments. FIG. 3 is merely one non-limiting example of an electromagnetic brake. Electric brake 60 is spring applied and electrically released. Braking torque is supplied by spring action and friction. Springs 96 provide a clamping force between a friction disc 98 and a pressure plate 100. Braking torque is supplied only when electrical energy is removed. An electromagnetic coil 102 is encased within electric brake 60. Connector 92 of FIG. 2B supplies electrical energy to electromagnetic coil 102. Energized electromagnetic coil 102 creates a magnetic field which compresses springs 96, allowing friction disc 98, which is splined or otherwise connected to hub 64, to rotate freely. When electrical energy is removed, the magnetic field is no longer created, allowing springs 96 to decompress. Decompressed springs 96 apply force between friction disc 98 and pressure plate 100. The pressure acts to prevent friction disc 98 and hub 64 from rotating freely.

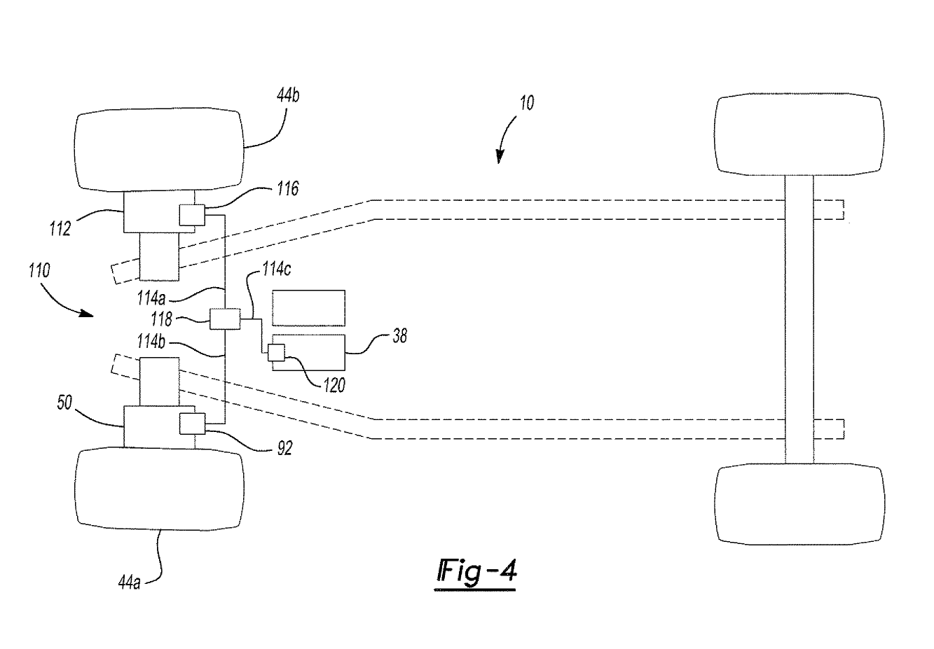

Referring to FIG. 4, a block diagram illustrates an assistive front electric brake control system in accordance with various embodiments. Front electric brake control system is shown generally at 110 and includes left front electric brake assembly 50 and a right front electric brake assembly 112. One or more wiring harnesses 114A-C connect between connector 92 of left electric brake 50, a connector 116 of right electric brake 112, a switching device 118, and a brake pedal detection device 120. Switching device 118 facilitates communication of an electrical signal generated by brake pedal detection device 120 to both left and right electric brakes 50 and 112. Switching device 118 can be a solid state device (i.e. Mosfet) or relay. Brake pedal detection device 120 couples to brake pedal 38 of golf car 10 and generates an electrical signal based on a position of brake pedal 38. Brake pedal detection device 120 can be a switch or sensor. When brake pedal 38 is depressed, brake pedal detection device 120 generates an electrical signal in accordance with the position of brake pedal 38. The electrical signal is then transmitted to both brakes 50 and 112 via wiring harnesses 114A-C and switching device 118. Based on the electrical signal, the front assistive electric brakes 50 and 112 are applied as described above. In various embodiments, the front assistive electric brakes 50 and 112 are applied based on a depression value of brake pedal 38 as indicated by brake pedal detection device 120.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A front electric brake assembly for assisting vehicle braking comprising:
a spindle that includes at least one mounting flange;
a shaft extending substantially perpendicular from the spindle;
an electric brake that mounts to the at least one mounting flange of the spindle; and
a hub assembly that rotates about the shaft and that interconnects with the electric brake.

2. The system of claim 1, the hub assembly comprising:
a hub including a spline detail that mates with the electric brake and a plurality of studs patterned to retain a front wheel;
a bearing set that is pressed into the hub; and
a spacer tube assembled between bearings of the bearing set.

3. The system of claim 1, the spindle mounts to a steering arm of a steering assembly.

4. The system of claim 2, the electric brake includes a spline detail that mates with the spline detail of the hub.

5. The system of claim 2, the electric brake is an electromagnetic brake comprising:
a friction disc including a spline detail that mates with the hub spline detail;
a pressure plate substantially adjacent to the friction disc;
an electric coil disposed within the electric brake;
a connector that receives an electrical signal and provides current to the electric coil based on the electrical signal, and when current is supplied to the electric coil, an electrical force is created; and
springs that compress and decompress based on the electrical force created by the electric coil and that when decompressed, provide force between the friction disc and the pressure plate.

6. An assistive front electric braking system for vehicles, comprising:
a left electric brake splined to a left front hub assembly for assisting vehicle braking;
a right electric brake splined to a right front hub assembly for simultaneously assisting vehicle braking;
a brake detection device that detects a position of a brake pedal and that generates an electrical signal based the position; and
a switching device that responds to the electrical signal and that transmits the electrical signal to the left and the right electric brakes respectively.

7. The system of claim 6, each of the left and the right hub assemblies comprising:
a hub including a spline detail that mates with the electric brake and a plurality of studs extending outwardly and patterned to retain a wheel assembly;
a bearing set that is pressed into the hub; and
a spacer tube assembled between bearings of the bearing set.

8. The system of claim 7, each of the left and the right electric brakes are electromagnetic brakes comprising:
a friction disc including a spline detail that mates with the hub spline detail;
a pressure plate substantially adjacent to the friction disc;
an electric coil disposed within the electric brake;
a connector that receives an electrical signal and provides current to the electric coil based on the electrical signal, and when current is supplied to the electric coil, an electrical force is created; and
springs that compress and decompress based on the electrical force created by the electric coil and that when decompressed, provide force between the friction disc and the pressure plate.

9. The system of claim 6, further comprising left and right spindles that each include at least one mounting flange, the left and right electric brakes mount to left and right spindles respectively via the at least one mounting flange.

10. The system of claim 9, the left and the right electric brakes include apertures, and the at least one of the mounting flange of the left and right spindles include apertures, and when the apertures are aligned fasteners extend through apertures in the left and the right electric brakes and apertures in the at least one mounting flanges of the spindles in order to mount the left and right electric brakes to the left and right spindles respectively.

11. The system of claim 9, further comprising:
a left shaft extending substantially perpendicular from the left spindle; and
a right shaft extending substantially perpendicular from the right spindle, the left and the right hub assemblies mount to and rotate on the left and right shafts respectively.

12. The system of claim 6, the switching device is at least one of a solid state device power electronics module and/or a relay and switch.

13. A light-weight utility vehicle, comprising:
a left front electric brake assembly coupled to a left front suspension system of the vehicle and that includes a left electric brake;
a right front electric brake assembly coupled to a right front suspension system of the vehicle and that includes a right electric brake;
a brake pedal detection device that generates an electrical signal to the left electric brake and the right electric brake, the electrical signal is generated in accordance with a position of a brake pedal of the vehicle.

14. The utility vehicle of claim 13, the left and the right front electric brake assemblies each comprising:
a spindle that includes at least one mounting flange, the electric brake mounts to the at least one mounting flange;
a shaft extending substantially perpendicular from the spindle; and
a hub assembly that rotates about the shaft and that interconnects with the electric brake.

15. The utility vehicle of claim 14, the hub assembly comprising:
a hub including a spline detail that mates with the electric brake and a plurality of studs patterned to retain a front wheel of the utility vehicle;
a bearing set that is pressed into the hub; and
a spacer tube assembled between bearings of the bearing set.

16. The utility vehicle of claim 15, further comprising a threaded nut that retains the hub assembly to the shaft, the shaft includes a threaded end portion for receiving the correspondingly threaded nut.

17. The utility vehicle of claim 15, further comprising a dust cap installed to the hub at an exposed end of the shaft.

18. The utility vehicle of claim 14, the spindle mounts to a steering arm of a steering assembly

19. The utility vehicle of claim 13, the electric brakes are electromagnetic brakes comprising:
a friction disc including a spline detail that mates with the hub spline detail;
a pressure plate substantially adjacent to the friction disc;
an electric coil disposed within the electric brake;
a connector that receives an electrical signal and provides current to the electric coil based on the electrical signal, when current is supplied to the electric coil, an electrical force is created; and
springs that compress and decompress based on the electrical force created by the electric coil and that when decompressed, provide force between the friction disc and the pressure plate.
